(19) United States
(12) Patent Application Publication
(10) Pub. No.: US 2026/0299610 A1
(43) Pub. Date: Oct. 1, 2026

(54) SMART DEVICE ASSISTED DRIVE

(71) Applicants: FCA US LLC, Auburn Hills, MI (US); Stellantis Auto SAS, Poissy (FR)

(72) Inventors: Ahmad N Saleh, Auburn Hills, MI (US); Daniel P Cashen, Auburn Hills, MI (US); Christopher R Piechocki, Auburn Hills, MI (US); Emily A Robb, Auburn Hills, MI (US)

(21) Appl. No.: 19/090,882

(22) Filed: Mar. 26, 2025

(51) Int. Cl. G05D 1/686; G05D 1/622; G05D 1/65; G05D 109/10; G05D 111/30; H04W 4/029; H04W 4/40; H04W 4/80

(52) U.S. Cl. CPC G05D 1/686; G05D 1/622; G05D 1/65; H04W 4/029; H04W 4/40; H04W 4/80; G05D 2109/10; G05D 2111/32

(57) ABSTRACT

A vehicle includes a transceiver configured to communicate with a portable electronic device paired with the vehicle and an advanced driver assistance system (ADAS) and/or autonomous driving system including a sensor system. An assisted drive system includes a vehicle controller configured to determine, by the transceiver, a location of the portable electronic device relative to the vehicle, receive one or more commands from a user of the portable electronic device outside of the vehicle to operate the vehicle in an auto-follow mode, determine, by the controller and the ADAS and/or autonomous driving system, a distance between the vehicle and the portable electronic device, and command, by the ADAS and/or autonomous driving system, the vehicle to operate in the auto-follow mode to automatically drive and follow the portable electronic device, based on one or more received commands from the user of the portable electronic device.

### FIELD

The present application relates generally to vehicle systems and, more particularly, to assisted driving systems for vehicles.

### BACKGROUND

It may be difficult to maneuver a vehicle in confined spaces such as parking garages, parking lots, and garages, for example, due to limited visibility and various obstacles. Moreover, some drivers are required to regularly move their vehicle short distances (e.g., for deliveries), requiring the driver to constantly exit and re-enter their vehicle, which may become highly inefficient. Accordingly, while such systems work well for their intended purpose, there remains a desire for improvement in the relevant art.

### SUMMARY

In accordance with one example aspect of the invention, a vehicle is provided. In one example, the vehicle includes a transceiver configured to communicate with a portable electronic device paired with the vehicle, an advanced driver assistance system (ADAS) and/or autonomous driving system including a sensor system, and an assisted drive system including a vehicle controller in signal communication with the transceiver and the sensor system. The vehicle controller includes one or more processors and a non-transitory computer-readable storage medium having a plurality of instructions stored thereon, which, when executed by the one or more processors, cause the one or more processors to perform operations including: determine, by the transceiver, a location of the portable electronic device relative to the vehicle; receive one or more commands from a user of the portable electronic device outside of the vehicle to operate the vehicle in an auto-follow mode; determine, by the controller and the ADAS and/or autonomous driving system, a distance between the vehicle and the portable electronic device; and command, by the ADAS and/or autonomous driving system, the vehicle to operate in the auto-follow mode to automatically drive and follow the portable electronic device, based on one or more received commands from the user of the portable electronic device.

In addition to the foregoing, the described vehicle may include one or more of the following features: wherein the transceiver is an ultra-wideband (UWB) transceiver configured to determine the location of the portable electronic device via one or more UWB signals; wherein the vehicle controller initiates a UWB ranging session between the transceiver and the portable electronic device, and subsequently determines the location of the portable electronic device based on time-of-flight information in the one or more UWB signals; wherein in the auto-follow mode, the controller commands the vehicle to follow the portable electronic device at a user-configurable predefined distance; and wherein in the auto-follow mode, the controller commands the vehicle to stop if the portable electronic device is no longer detected.

In addition to the foregoing, the described vehicle may include one or more of the following features: wherein in the auto-follow mode, the controller is configured to monitor, via the sensor system, an area around the vehicle to detect one or more obstacles/objects within a path of travel of the vehicle; wherein in the auto-follow mode, the controller commands the vehicle to stop if one or more obstacles/objects are detected within the path of travel of the vehicle; and wherein in the auto-follow mode, the controller is configured to limit a speed of the vehicle to a predefined maximum low speed.

In addition to the foregoing, the described vehicle may include one or more of the following features: wherein the transceiver and the portable electronic device are configured to communicate signals therebetween, the communicated signals including authentication information to confirm the portable electronic device is authorized to control a function of the vehicle; wherein the transceiver is a Bluetooth transceiver, and the communicated signals are Bluetooth signals; and a telematics device configured for communication with the portable electronic device via a network, wherein the vehicle controller utilizes the telematics device to determine a vehicle GPS location, the distance to the portable electronic device, and the portable electronic device GPS location.

In accordance with another example aspect of the invention, a computer-implemented method of operating a vehicle having a transceiver configured to communicate with a portable electronic device paired with the vehicle, an advanced driver assistance system (ADAS) and/or autonomous driving system including a sensor system, and a vehicle controller having one or more processors is provided. In one example, the method includes determining, by the controller and the transceiver, a location of the portable electronic device relative to the vehicle; receiving, at the controller, one or more commands from a user of the portable electronic device outside of the vehicle to operate the vehicle in an auto-follow mode; determining, by the controller and the ADAS and/or autonomous driving system, a distance between the vehicle and the portable electronic device; and commanding, by the controller and the ADAS and/or autonomous driving system, the vehicle to operate in the auto-follow mode to automatically drive and follow the portable electronic device, based on one or more received commands from the user of the portable electronic device.

In addition to the foregoing, the described method may include one or more of the following features: wherein the transceiver is an ultra-wideband (UWB) transceiver configured to determine the location of the portable electronic device via one or more UWB signals; initiating, by the vehicle controller, a UWB ranging session between the transceiver and the portable electronic device, and subsequently determining the location of the portable electronic device based on time-of-flight information in the one or more UWB signals; commanding, by the controller and during the auto-follow mode, the vehicle to follow the portable electronic device at a user-configurable predefined distance; and commanding, by the controller and during the auto-follow mode, the vehicle to stop if the portable electronic device is no longer detected.

In addition to the foregoing, the described method may include one or more of the following features: monitoring, via the sensor system, an area around the vehicle to detect one or more obstacles/objects within a path of travel of the vehicle; commanding, by the controller and during the auto-follow mode, the vehicle to stop if one or more obstacles/objects are detected within the path of travel of the vehicle; limiting, by the controller and during the auto-follow mode, a speed of the vehicle to a predefined maximum low speed; and wherein the transceiver and the portable electronic device are configured to communicate signals therebetween, the communicated signals including authentication information to confirm the portable electronic device is authorized to control a function of the vehicle.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of an example vehicle assisted driving system in accordance with the principles of the present application;

FIG. 2 is a functional block diagram of a portion of the assisted driving system shown in FIG. 1, in accordance with the principles of the present application; and

FIG. 3 is a flow diagram illustrating an example method of operating the assisted driving system of FIG. 1, in accordance with the principles of the present application.

### DETAILED DESCRIPTION

As previously discussed, it may be difficult to perform traditional driving maneuvers in confined spaces such as parking garages, parking lots, and home garages. Further, it may be inefficient to regularly enter and exit to move the vehicle short distances, for example, when making deliveries. Accordingly, systems and methods are provided for remotely activating a vehicle to follow a driver/user located outside of the vehicle, for example, when the vehicle is in a challenging maneuverability environment or in situations when the user intends to walk to a destination, but requires the vehicle in close proximity.

In one example, the vehicle includes an advanced driver assistance system (ADAS) with object detection capability. The vehicle is configured to communicate with a personal electronic device (e.g., smart phone), for example, via Bluetooth (BT/BLE) and ultra-wide band (UWB) wireless technologies. The personal electronic device is utilized for car access/control (e.g., lock/unlock), and the vehicle is configured to authenticate and localize the personal electronic device to enable the user to command the vehicle to follow the user in a safe and secure manner.

In general, the vehicle includes an assisted driving system equipped to allow the personal electronic device to be used as a key for the vehicle. The vehicle utilizes BLE/UWB for distance measurements and localization of the device in proximity to the vehicle. The assisted driving system is configured to support the vehicle or the device or both to exchange information and further utilize UWB distance measurements to reduce any error and improve the overall location sensing between the vehicle and the personal electronic device (the user).

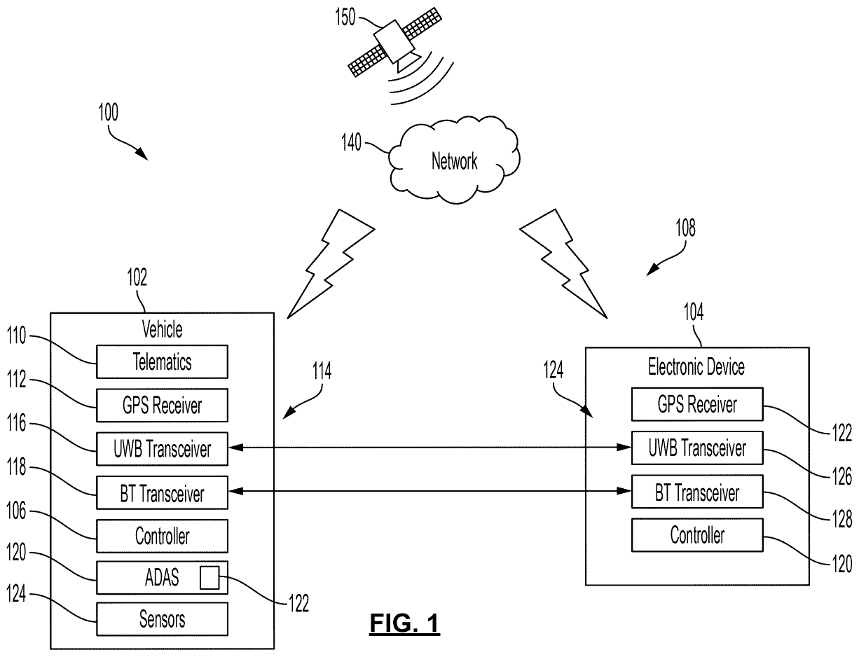

With reference now to FIG. 1, an example communication system 100 is illustrated in accordance with the principles of the present disclosure. In the example embodiment, the communication system 100 generally includes a vehicle 102 and a portable electronic device 104 (e.g., smart phone, laptop computer, tablet computer, etc.) that are each capable of a high level of accurate location sensing. However, it will be appreciated that communication system 100 is not limited thereto and may be utilized with other objects capable of a high level of accurate location sensing. As described herein in more detail, the communication system 100 utilizes the existing wireless communications systems (e.g., BLE/UWB) in the vehicle 102 and portable electronic device 104, and a communication link therebetween for distance measurements and location sensing of the vehicle 102 and electronic device 104.

In the example embodiment, the vehicle 102 generally includes a computing device or controller 106 (e.g., ECU) as part of an assisted drive system 108 that enables a user to operate the vehicle in an auto-follow mode to initiate/control movement of the vehicle 102 from outside thereof, as described herein in more detail. The controller 106 is in signal communication with a telematics device 110, a GPS receiver 112, and one or more wireless transceivers 114. The controller 106 includes a processor and a memory and may be separate from or part of various other vehicle devices/controllers. The telematics device 110 is a device designed to ensure the wireless connectivity of the vehicle 102 and enables the exchange of data with external infrastructure such as a network 140 and portable electronic device 104. The network 140 can be any suitable communication network including, for example, a satellite network, a cellular network (3G, 4G LTE, 5G, etc.), a computing network (local area network, the internet, etc.), or some combination thereof.

The GPS receiver 112 may be part of or separate from the telematics device 110. The GPS receiver 112 can comprise one or more receivers or antennas configured to receive signals from a plurality of satellites 150. For example, the GPS receiver 112 may be a global navigation satellite systems (GNSS) antenna. Based on the signals from the satellites 150, the GPS receiver 112 can output a position signal that is indicative of the spatial position of the GPS receiver 112.

The wireless transceiver(s) 114 are utilized for detection and ranging of the electronic device 104 when paired with the vehicle 102. In the example embodiment, transceivers 114 include a UWB transceiver 116 configured to transmit and receive UWB signals, and a Bluetooth (BT) transceiver 118 configured to transmit and receive BT signals. However, it will be appreciated that transceiver 114 may be capable of transmitting any suitable type of signal such as, for example ultra-high frequency (UHF), Wi-Fi, etc. In one example, the controller 106 is configured to transmit a continuous signal (e.g., UWB/BT signal) a predefined distance (e.g., five meters) via the transceiver 114. When the paired electronic device 104 comes within the predefined distance and receives the signal, the electronic device 104 is activated and responds back to the vehicle 102 via the transceiver 114 with a response signal acknowledging its presence in the vehicle vicinity.

In the example implementation, the vehicle 102 also includes an ADAS/autonomous driving system 120 that includes a controller 122 in signal communication with a sensor suite 124. The controller 122 may be separate from or part of controller 106 and may include various ADAS/autonomous driving functionality such as, for example, ADAS function, object detection algorithms, and automated drive function. The sensor suite 124 generally includes a plurality of sensors to facilitate ADAS/autonomous driving of the vehicle 102. For example, the sensor suite 124 may include a vehicle speed sensor, a vehicle steering sensor, wheel speed sensors (e.g., one for each wheel), accelerometer(s), a throttle position sensor, a brake sensor, blind spot monitoring/cross path sensor(s), ultrasonic park sensor(s), and one or more cameras (e.g., back up, park view side, drone, etc.) (not shown). However, it will be appreciated that sensor suite 124 may include any additional sensors that enable assisted driving system 108 to function as described herein. The ADAS/autonomous driving system 120, which integrates with or is part of assisted driving system 108, may include steer-by-wire, throttle-by-wire, and brake-by-wire modules (not shown) or functionality.

In the example embodiment, the portable electronic device 104 generally includes a computing device or controller 130, a GPS receiver 132, one or more wireless transceivers 134, and a display (not shown). The controller 130 includes a processor and a memory. The electronic device 104 is configured for communication via the network 140 (e.g., satellites 150), and the processor is configured to control operation thereof. The term “processor” as used herein can refer to both a single processor and two or more processors operating in a parallel or distributed architecture. The memory can be any suitable storage medium (flash, hard disk, etc.) configured to store information at electronic device 104. In one implementation, the memory is a non-transitory computer-readable storage medium configured to store instructions executable by the processor to cause the electronic device 104 to perform at least a portion of the disclosed techniques. The display may be a touchscreen display configured to display one or more soft buttons (not shown) to facilitate performing at least a portion of the disclosed techniques. Moreover, the electronic device 104 is capable of installing and executing instructions from one or more computer applications.

The GPS receiver 132 can comprise one or more receivers or antennas configured to receive signals from the plurality of satellites 150. For example, the GPS receiver 132 may be a global navigation satellite systems (GNSS) antenna. Based on the signals from the satellites 150, the GPS receiver 132 can output a position signal that is indicative of the spatial position of the GPS receiver 132 and thus electronic device 104.

The wireless transceiver(s) 134 are utilized for detection and ranging of the vehicle 102 when paired therewith. In the example embodiment, transceivers 134 include a UWB transceiver 136 configured to transmit and receive UWB signals, and a BT transceiver 138 configured to transmit and receive BT signals. However, it will be appreciated that transceiver 134 may be capable of transmitting any suitable type of signal such as, for example ultra-high frequency (UHF), Wi-Fi, etc. In one example, the controller 130 is configured to detect a signal (e.g., UWB/BT signal) transmitted from the vehicle 102 via the transceiver 134. When the paired electronic device 104 comes within the predefined distance and receives the signal, the electronic device 104 is activated and responds back to the vehicle 102 via the transceiver 114 with a response signal acknowledging its presence in the vehicle vicinity.

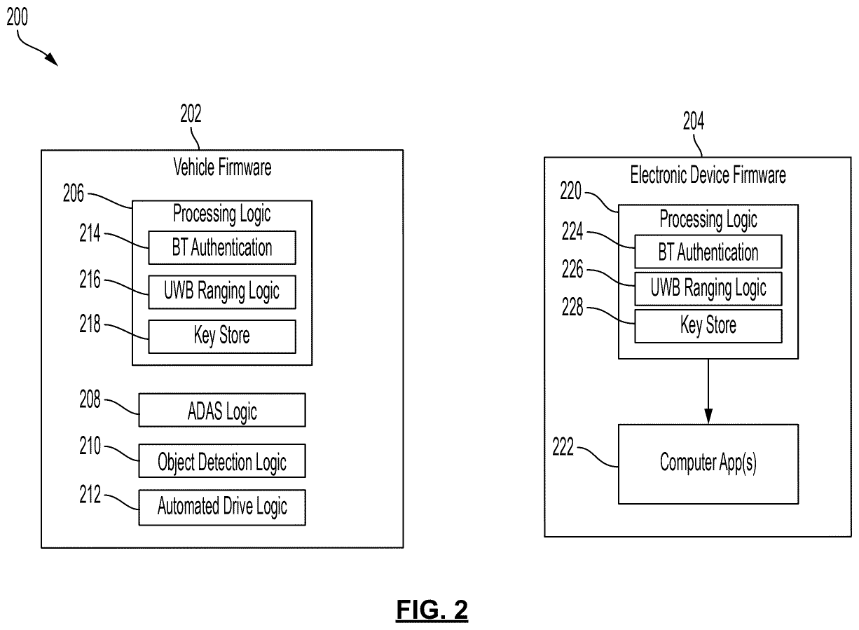

With reference now to FIG. 2, a schematic diagram 200 illustrates an example vehicle firmware 202 of vehicle 102 and electronic device firmware 204 of the electronic device 104. In the example embodiment, the vehicle firmware 202 generally includes a processing logic 206, ADAS logic 208, an object detection logic 210, and an automated drive logic 212. The processing logic 206 is a vehicle access function configured to enable electronic device 104 to be utilized as a key for the vehicle 102, for example, to lock/unlock doors and start the vehicle ignition. The processing logic 206 includes a BT authentication logic 214, a UWB ranging logic 216, and a key store 218. The BT authentication logic 214 is configured to authenticate the electronic device 104 via one or more BT signals. The UWB ranging logic 216 is configured to determine a range to the electronic device 104 via one or more UWB signals. The key store 218 is a secure storage device that stores authentication keys or other sensitive/private information.

The ADAS logic 208 is configured to monitor and receive signals from the sensors 124, as well as send sensor data to various vehicle components, such as controllers 106, 122. The object detection logic 210 is configured to detect objects, including a user positioned outside of the vehicle 102 with an authenticated electronic device 104. In one example the object detection logic 210 utilizes inputs from the processing logic 206 and the ADAS logic 208.

In the example embodiment, the electronic device firmware 204 generally includes a processing logic 220 and one or more computer applications 222. The processing logic 220 is configured to enable electronic device 104 to be utilized as a key for the vehicle 102, for example, to lock/unlock doors and start the vehicle ignition. The processing logic 220 includes a BT authentication logic 224, UWB ranging logic 226, and a key store 228. The BT authentication logic 224 is configured to authenticate the electronic device 104 with the vehicle 102 via one or more BT signals. The UWB ranging logic 226 is configured facilitate determining the range from the electronic device 104 to the vehicle 102 via one or more UWB signals. The key store 228 is a secure storage device that stores authentication keys or other sensitive/private information. The processing logic 220 is configured to provide location information to the one or more computer applications 222 that operate on the electronic device 104 to enable control of the auto-follow mode.

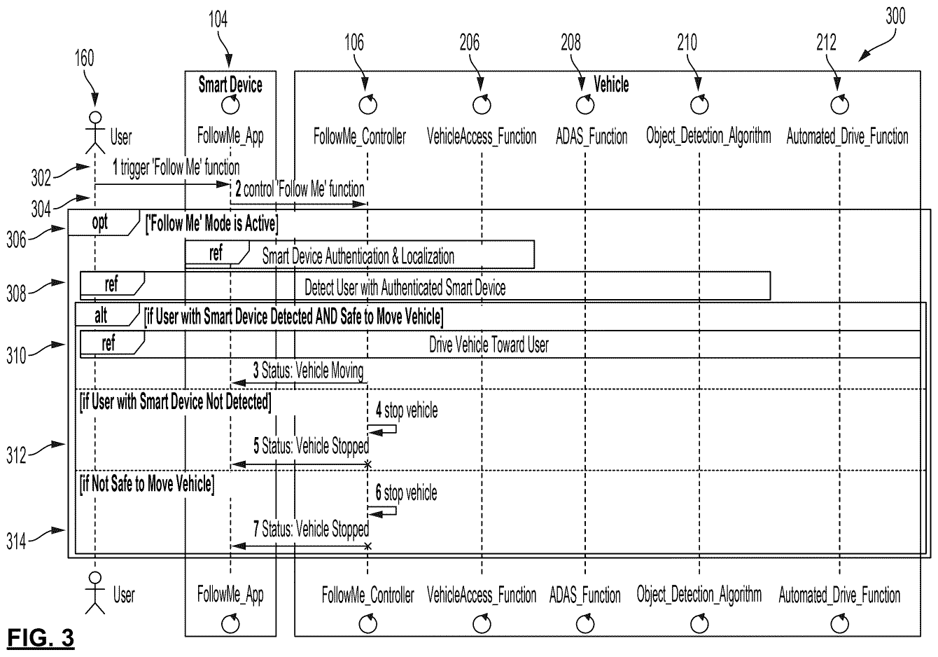

With reference now to FIG. 3, a flow diagram of an example vehicle auto-follow mode of operation 300 of the assisted driving system 108 is illustrated according to the principles of the present disclosure. While the operation 300 specifically references the electrified vehicle 102 and its components for illustrative/descriptive purposes, it will be appreciated that the method 300 could be applicable to any suitably configured electrified vehicle. The operation begins at 302 where a user 160 initiates an automatic vehicle following function using the portable electronic device 104, also referred to as a “follow me” function. This action may be initiated, for example, via a computer application on the electronic device 104.

At 304, electronic device 104 sends a signal to vehicle 102 (e.g., controller 106) that the vehicle auto-follow mode/function is initiated. At 306, controller 106 (“control”) authenticates and localizes the electronic device 104, for example, via processing logic 206. In one example, the vehicle controller 106 utilizes UWB signals between UWB transceivers 116, 136 to estimate a location/distance of the electronic device 104. For example, UWB leverages time-of-flight techniques to measure the distance between two radio transceivers by multiplying the time-of-flight of the signal by the speed of light. In another example, the controller 106 initiates a UWB ranging session between the transceivers 116, 136, and subsequently determines the location of the portable electronic device 104 based on time-of-flight information in one or more UWB signals exchanged therebetween.

At 308, once the electronic device 104 is authenticated and localized relative to the vehicle 102 (e.g., distance determined therebetween), control detects the user 160 and electronic device 104, for example, via the processing logic 206, the ADAS logic 208 and/or the object detection logic 210.

At 310, control operates the vehicle 102 to follow/drive toward the user 160 and electronic device 104. For example, the vehicle 102 may then be commanded to follow (drive behind) the user 160/electronic device 104 utilizing the processing logic 206, the ADAS logic 208, the object detection logic 210, and/or the automated drive logic 212. In some examples, the vehicle 102 may be operated to follow the user 160/electronic device 104 at a predefined distance (e.g., 3 ft) or predefined range (e.g., 2-6 ft). This predefined distance may be adjustable/configurable by the user via the electronic device 104. The vehicle 102 may also operate/drive at a speed configured to maintain the predefined distance or predefined range between the vehicle 102 and the user 160/electronic device 104. Control may limit a speed of the vehicle to a predetermined maximum low-speed (e.g., 4 mph) at which to follow the user 160/electronic device 104. In another example, the electronic device 104 (e.g., computer application) may be utilized by the user 160 for specific driving control of the vehicle (e.g., forward, reverse, turn, stop, follow at a predetermined safe distance, etc.) while the user 160 is outside of the vehicle 102 and within a detectable range.

At 312, control continuously monitors for detection of the electronic device 104. If the electronic device 104 is authenticated/localized, then control remains enabled to drive the vehicle 102, for example, automatically and/or via user control through the electronic device 104. However, if vehicle 102 no longer detects the electronic device 104, control commands the vehicle 102 to stop. Upon the electronic device 104 being subsequently re-identified, authenticated, and localized, the automated driving may be re-enabled.

At 314, control also continuously monitors the area surrounding the vehicle 102 using the ADAS/autonomous driving system 120 (e.g., sensors 124) and object detection logic 210. If the vehicle 102 does not detect any obstacles/objects (e.g., pedestrians, other vehicles, curbs, etc.), then control remains enabled to drive the vehicle 102, for example, automatically and/or via user control through the electronic device 104. However, if the vehicle 102 detects one or more obstacles/objects within its path of travel, then control commands the vehicle 102 to stop. Upon the obstacles/objects no longer being detected, the automated driving may be re-enabled. Control may then end until another initiation of the auto-follow mode.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

1. An automotive passenger vehicle, comprising:
a transceiver configured to communicate with a portable electronic device paired with the vehicle;
an advanced driver assistance system (ADAS) comprising a steer-by-wire module, a throttle-by-wire module, a brake-by-wire module, and a sensor system, which includes a vehicle speed sensor, a vehicle steering sensor, wheel speed sensors, one or more accelerometers, blind spot monitoring/cross path sensors, ultrasonic park sensors, and one or more cameras; and
an assisted drive system including a vehicle controller in signal communication with the transceiver and the sensor system, the vehicle controller including one or more processors and a non-transitory computer-readable storage medium having a plurality of instructions stored thereon, which, when executed by the one or more processors, cause the one or more processors to perform operations comprising:
determine, by the transceiver, a location of the portable electronic device relative to the vehicle;
receive one or more commands from a user of the portable electronic device outside of the vehicle to operate the vehicle in an auto-follow mode;
determine, by the controller and the ADAS, a distance between the vehicle and the portable electronic device; and
command, by the ADAS and the steer-by-wire module and the throttle-by-wire module, the vehicle to operate in the auto-follow mode to automatically drive, steer, and follow the portable electronic device, based on one or more received commands from the user of the portable electronic device.

2. The vehicle of claim 1, wherein the transceiver is an ultra-wideband (UWB) transceiver configured to determine the location of the portable electronic device via one or more UWB signals.

3. The vehicle of claim 2, wherein the vehicle controller initiates a UWB ranging session between the transceiver and the portable electronic device, and subsequently determines the location of the portable electronic device based on time-of-flight information in the one or more UWB signals.

4. The vehicle of claim 1, wherein in the auto-follow mode, the controller commands the vehicle to follow the portable electronic device at a user-configurable predefined distance.

5. The vehicle of claim 1, wherein in the auto-follow mode, the controller commands the vehicle to stop if the portable electronic device is no longer detected.

6. The vehicle of claim 1, wherein in the auto-follow mode, the controller is configured to further perform the following operations:
monitor, via the sensor system, an area around the vehicle to detect one or more obstacles/objects within a path of travel of the vehicle,
wherein in the auto-follow mode, the controller commands the vehicle to stop if one or more obstacles/objects are detected within the path of travel of the vehicle.

7. (canceled)

8. The vehicle of claim 1, wherein in the auto-follow mode, the controller is configured to limit a speed of the vehicle to a predefined maximum low speed.

9. The vehicle of claim 1, wherein the transceiver and the portable electronic device are configured to communicate signals therebetween, the communicated signals including authentication information to confirm the portable electronic device is authorized to control a function of the vehicle.

10. The vehicle of claim 9, wherein the transceiver is a Bluetooth transceiver, and the communicated signals are Bluetooth signals.

11. The vehicle of claim 1, further comprising a telematics device configured for communication with the portable electronic device via a network, wherein the vehicle controller utilizes the telematics device to determine a vehicle GPS location, the distance to the portable electronic device, and the portable electronic device GPS location.

12. A computer-implemented method of operating an automotive passenger vehicle having a transceiver configured to communicate with a portable electronic device paired with the vehicle, an advanced driver assistance system (ADAS) comprising a steer-by-wire module, a throttle-by-wire module, a brake-by-wire module, and a sensor system, which includes a vehicle speed sensor, a vehicle steering sensor, wheel speed sensors, one or more accelerometers, blind spot monitoring/cross path sensors, ultrasonic park sensors, and one or more cameras, and a vehicle controller having one or more processors, the method comprising:
determining, by the controller and the transceiver, a location of the portable electronic device relative to the vehicle;
receiving, at the controller, one or more commands from a user of the portable electronic device outside of the vehicle to operate the vehicle in an auto-follow mode;
determining, by the controller and the ADAS, a distance between the vehicle and the portable electronic device; and
commanding, by the controller and the ADAS, including the steer-by-wire module and the throttle-by-wire module, the vehicle to operate in the auto-follow mode to automatically drive, steer, and follow the portable electronic device, based on one or more received commands from the user of the portable electronic device.

13. The method of claim 12, wherein the transceiver is an ultra-wideband (UWB) transceiver configured to determine the location of the portable electronic device via one or more UWB signals.

14. The method of claim 13, further comprising initiating, by the vehicle controller, a UWB ranging session between the transceiver and the portable electronic device, and subsequently determining the location of the portable electronic device based on time-of-flight information in the one or more UWB signals.

15. The method of claim 12, further comprising:
commanding, by the controller and during the auto-follow mode, the vehicle to follow the portable electronic device at a user-configurable predefined distance.

16. The method of claim 12, further comprising:
commanding, by the controller and during the auto-follow mode, the vehicle to stop if the portable electronic device is no longer detected.

17. The method of claim 12, further comprising:
monitoring, via the sensor system, an area around the vehicle to detect one or more obstacles/objects within a path of travel of the vehicle; and
commanding, by the controller and during the auto-follow mode, the vehicle to stop if one or more obstacles/objects are detected within the path of travel of the vehicle.

18. (canceled)

19. The method of claim 12, further comprising:
limiting, by the controller and during the auto-follow mode, a speed of the vehicle to a predefined maximum low speed.

20. The method of claim 12, wherein the transceiver and the portable electronic device are configured to communicate signals therebetween, the communicated signals including authentication information to confirm the portable electronic device is authorized to control a function of the vehicle.

21. An automotive passenger vehicle, comprising:
a transceiver configured to communicate with a portable electronic device paired with the vehicle and configured to be utilized as a key for the vehicle to lock/unlock vehicle doors and start an ignition of the vehicle;
an advanced driver assistance system (ADAS) comprising a steer-by-wire module, a throttle-by-wire module, a brake-by-wire module, and a sensor system, which includes a vehicle speed sensor, a vehicle steering sensor, wheel speed sensors, one or more accelerometers, blind spot monitoring/cross path sensors, ultrasonic park sensors, and one or more cameras; and
an assisted drive system including a vehicle controller in signal communication with the transceiver and the sensor system, the vehicle controller including one or more processors and a non-transitory computer-readable storage medium having a plurality of instructions stored thereon, which, when executed by the one or more processors, cause the one or more processors to perform operations comprising:
determine, by the transceiver, a location of the portable electronic device relative to the vehicle;
receive one or more commands from a user of the portable electronic device outside of the vehicle to operate the vehicle in an auto-follow mode;
determine, by the controller and the ADAS, a distance between the vehicle and the portable electronic device;
command, by the ADAS and the steer-by-wire module and the throttle-by-wire module, the vehicle to operate in the auto-follow mode to automatically drive, steer, and follow the portable electronic device, based on one or more received commands from the user of the portable electronic device;
monitor, via the sensor system, an area around the vehicle to detect one or more obstacles/objects within a path of travel of the vehicle; and
command, by the brake-by-wire module, the vehicle to stop if one or more obstacles/objects are detected within the path of travel of the vehicle.

22. The vehicle of claim 21, wherein the transceiver comprises:
a Bluetooth transceiver configured to communicate Bluetooth signals between the Bluetooth transceiver and the portable electronic device, where the vehicle controller subsequently confirms, based on authentication information included in the communicated Bluetooth signals, that the portable electronic device is authorized to control a function of the vehicle; and
an ultra-wideband (UWB) transceiver configured to determine the location of the portable electronic device via a UWB ranging session between the UWB transceiver and the portable electronic device, where the vehicle controller subsequently determines the location of the portable electronic device based on time-of-flight information in one or more UWB signals transmitted during the UWB ranging session.
